(19) United States
(12) Patent Application Publication
(10) Pub. No.: US 2014/0006174 A1
(43) Pub. Date: Jan. 2, 2014

(54) SYSTEMS AND TECHNIQUES FOR DETERMINING A QUANTITY OF DISPLAYABLE CONTENT UNITS WITHIN A FRAME

(71) Applicants: Brandon M. Pearcy, San Francisco, CA (US); Nathan P. Lucash, San Francisco, CA (US)

(72) Inventors: Brandon M. Pearcy, San Francisco, CA (US); Nathan P. Lucash, San Francisco, CA (US)

(73) Assignee: GOOGLE INC., Mountain View, CA (US)

(21) Appl. No.: 13/536,247

(22) Filed: Jun. 28, 2012

(51) Int. Cl. G06Q 30/02

(52) U.S. Cl. 705/14.73

(57) ABSTRACT

Systems and techniques are described for advertisement retrieval and display formatting. A described technique includes receiving a request associated with a website to retrieve advertisement content for display within a frame of a display of the website, the request including dimensional values defining dimensions of the frame; obtaining advertisement display parameters that control display of content within the frame; determining a maximal quantity of advertisement content units that are fully displayable within the frame based on the dimensional values and a plurality of different combinations of the advertisement display parameters, obtaining advertisements based on the determined maximal quantity; and providing the obtained advertisements for display within the frame. Determining the maximal quantity can include determining maximal advertisement content unit quantities, respectively, for the different combinations of the advertisement display parameters; and selecting one of the maximal advertisement content unit quantities as the determined maximal quantity.

### TECHNICAL FIELD

This patent document relates to advertising and determining aspects associated with displaying advertisement content via a network such as the Internet.

### BACKGROUND

Publishers of websites can optimize the delivery of advertisements to receptive audiences via the Internet. One form of online advertising is advertisement syndication, which allows advertisers to extend their marketing reach by distributing advertisements to additional partners. For example, a third party online publisher can place an advertiser's sponsored content, such as text or image advertisements, on a website with desirable content to drive online customers to the advertiser's website. An online publisher can use an advertising intermediary that selects and causes advertisements to be displayed on the online publisher's website when rendered on a browser. In some cases, the advertising intermediary can select one or more advertisements that are relevant based on the contents of the online publisher's website.

### SUMMARY

Systems and techniques are described for advertisement retrieval and display formatting. A described technique includes receiving a request associated with a website to retrieve advertisement content for display within a frame of a display of the website, the request including dimensional values defining dimensions of the frame; obtaining advertisement display parameters that control display of content within the frame; determining a maximal quantity of advertisement content units that are fully displayable within the frame based on the dimensional values and a plurality of different combinations of the advertisement display parameters, obtaining advertisements based on the determined maximal quantity; and providing the obtained advertisements for display within the frame. Determining the maximal quantity can include determining maximal advertisement content unit quantities, respectively, for the different combinations of the advertisement display parameters; and selecting one of the maximal advertisement content unit quantities as the determined maximal quantity.

These and other implementations can include one or more of the following features. Selecting one of the maximal advertisement content unit quantities as the determined maximal quantity can include selecting the largest one of the maximal advertisement content unit quantities as the determined maximal quantity. Selecting one of the maximal advertisement content unit quantities as the determined maximal quantity can include selecting the smallest one of the maximal advertisement content unit quantities as the determined maximal quantity. The advertisement display parameters can include font-types, font-sizes, browser types, operating system types, screen resolutions, or inter-advertisement padding values. Obtaining advertisement display parameters can include accessing first advertisement display parameters that correspond to a first degree of freedom; and accessing second advertisement display parameters that correspond to a different second degree of freedom. Implementations can include retrieving a configuration parameter associated with the website, where the configuration parameter constrains the plurality of different combinations of the advertisement display parameters in at least one degree of freedom. Determining the maximal quantity can include detecting a language associated with the website; and retrieving a word-length distribution associated with the language, the maximal quantity being further based on the word-length distribution. In some implementations, the frame is a rectangular frame. The dimensional values can include a width value defining a width of the rectangular frame and a height value defining a height of the rectangular frame. Determining the maximal quantity of advertisement content units can include dividing the rectangular frame into multiple smaller rectangular frames based on the width value, the height value, or both.

A described system includes a network interface configured to receive data including a request associated with a website to retrieve advertisement content for display within a frame of a display of the website, the request including dimensional values defining dimensions of the frame; and a processor in communication with the network interface configured to perform operations. The operations can include obtaining advertisement display parameters that control display of content within the frame; determining a maximal quantity of advertisement content units that are fully displayable within the frame based on the dimensional values and a plurality of different combinations of the advertisement display parameters; obtaining advertisements based on the determined maximal quantity; and providing the obtained advertisements for display within the frame. Determining the maximal quantity can include determining maximal advertisement content unit quantities, respectively, for the different combinations of the advertisement display parameters; and selecting one of the maximal advertisement content unit quantities as the determined maximal quantity.

In another aspect, a described system includes a first server configured to receive data including a request associated with a website to retrieve advertisement content for display within a frame of a display of the website, the request including dimensional values defining dimensions of the frame. The system can include a second server configured to perform operations that include obtaining advertisement display parameters that control display of content within the frame; and determining a maximal quantity of advertisement content units that are fully displayable within the frame based on the dimensional values and a plurality of different combinations of the advertisement display parameters. Determining the maximal quantity can include determining maximal advertisement content unit quantities, respectively, for the different combinations of the advertisement display parameters; and selecting one of the maximal advertisement content unit quantities as the determined maximal quantity. The first server can be configured to obtain advertisements based on the determined maximal quantity and provide the obtained advertisements for display within the frame.

Particular configurations of the subject matter described in this document can be implemented so as to realize one or more of the following potential advantages. A described technique can help ensure that the entirety of one or more advertisements are fully displayed to a potential customer. The described technique allows online publishers to freely select dimensions of one or more rectangular frames for displaying advertisement content on their respective websites. Moreover, an advertising intermediary can use a described technique to help ensure compliance with contractual agreements between the advertising intermediary and advertisers that pay for advertisements to be fully displayed.

Details of one or more implementations of subject matter described in this document are set forth in the accompanying drawings and the description below. Other features, aspects, and advantages will become apparent from the description, the drawings, and the claims.

### BRIEF DESCRIPTION OF THE DRAWINGS

FIG. 1 shows an example of a network architecture.

FIG. 2 shows an example of a layout of a webpage that includes frames with

advertisement content.

FIGS. 3A and 3B show different examples of a layout of a frame that includes

a truncated advertisement content unit.

FIG. 4 shows an example of process that includes determining a maximal

quantity of advertisement content units that are fully displayable within a rectangular frame.

FIG. 5 shows an example of process to determine a maximal quantity of advertisement content units based on a group of configurations.

Like reference numbers and designations in the various drawings indicate like elements.

### DETAILED DESCRIPTION

Advertising intermediaries solicit advertisements from entities such as businesses, and selectively provide them for display within third party websites. For example, an intermediary can select advertisements that are relevant to a website from which the advertisements will be displayed or to one or more attributes of a viewer of the website. The systems and techniques described in this document enable an advertising intermediary to help ensure advertisements are fully displayed to potential customers within a frame of a website, the frame having dimensions that are not controlled by the advertising intermediary. Advertising intermediaries can be compensated for their services based on the number of times a given advertisement has been displayed or clicked. The systems and techniques determine a maximal quantity of advertisements that can be fully displayed within a frame, which can increase advertisement revenue.

When an advertising intermediary, for example, receives an advertisement request for displaying text based advertisements within a frame, the intermediary is required to determine how many text advertisements are displayable within the frame. Such a determination can take into account aspects such as the average length of text advertisements within an advertisement database (e.g. the average number of characters per word multiplied by the average number of words in an advertisement), potential font-types and font-sizes for displaying the advertisements, potential layouts of the text (e.g. all on one line, or multiple lines), browser type of an end-user's browser, and operating system type of an end-user's device.

An advertising intermediary is typically obligated to cause the rendering of the text advertisements in their entirety since the businesses paying for the intermediary's services expect this. In some cases, an advertising intermediary can manually estimate, for a predetermined selection of frame dimensions, the number of text advertisements that can fit into the frame. However, it may be cost prohibitive for the intermediary to codify the maximum number of text advertisements that could be shown for every possible combination of aspects (e.g., degrees of freedom). Various example of aspects include font-face, font-size, browser type, operating system type, text layout, padding, margins, advertisement unit width, and advertisement unit height. The number of such combinations grows exponentially whenever a new aspect is taken into consideration. As the number of aspects increase, the intermediary may become more conservative in selecting a displayable advertisement quantity to ensure that the advertisements will be fully displayed. However, selecting a submaximal quantity usually decreases advertisement revenue. A technique described herein can automatically determine a maximal quantity of advertisements while ensuring an intermediary's obligations are met.

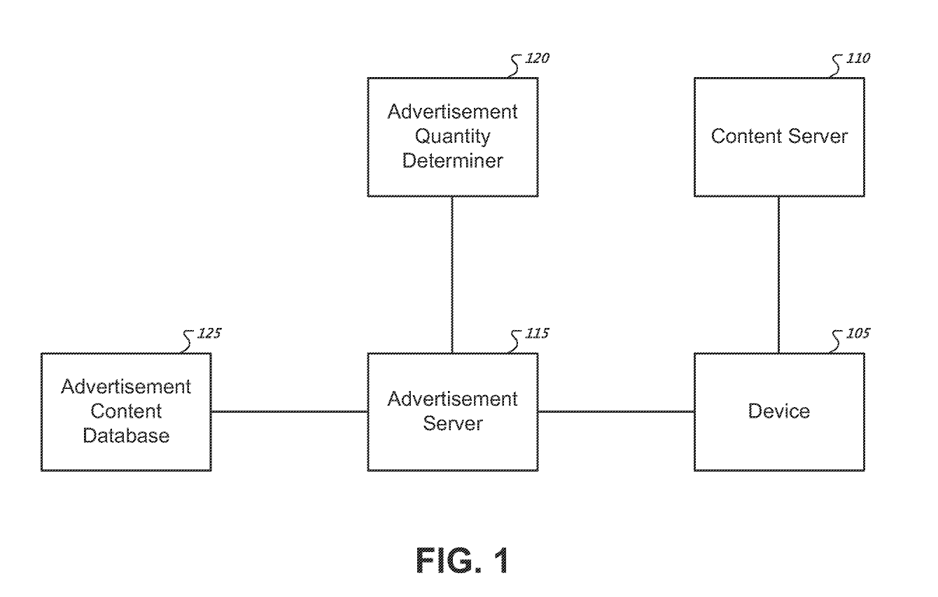

FIG. 1 shows an example of a network architecture that includes hardware to determine a maximal advertisement quantity. A device 105 such as a desktop computer, mobile phone, or a tablet can access a website via a content server 110. The content server 110 can send content to the device 105. The content can include text, graphics, audio, video, a script for user-interaction, or a combination thereof. The device 105 can render the content to an output such as a monitor, speakers, or both. The content can include a universal resource locator (URL) for retrieving one or more advertisements via an advertisement server 115. The device 105 can display advertisement content within a rectangular frame of a display of the website. Other types of frames are possible such as circles, variants thereof and polygons in general.

The advertisement related URL can indicate a network address for the advertisement server 115. Based on parsing an advertisement related URL, the device 105 can send an advertisement request to the advertisement server 115. The advertisement request can include dimensional values defining dimensions of the rectangular frame. The dimensional values can include a width value defining a width of the rectangular frame, a height value defining a height of the rectangular frame, or both. In some implementations, the dimensional values can include a value indicating a diagonal value. The rectangular frame can include one or more advertisement content units, with each unit displaying its own separate advertisements.

Based on receiving an advertisement request, the advertisement server 115 can send information, including the dimensional values, to an advertisement quantity determiner 120. Providing too many advertisements to the device 105 may cause the device 105 to truncate a portion of one or more advertisements, which is typically unacceptable to a business paying for the advertisement to be displayed. Thus, the advertisement quantity determiner 120 can be configured to determine a maximal quantity of advertisement content units that are fully displayable within a rectangular frame defined by the dimensional values. The advertisement quantity determiner 120 includes hardware such as one or more processors.

The advertisement quantity determiner 120 provides the determined maximal quantity value to the advertisement server 115. Based on the value, the advertisement server 115 retrieves a corresponding quantity of advertisements from the advertisement content database 125 and provides the retrieved advertisements to the device 105. The advertisement server 115 can include a processor and a network interface for communicating with one or more networks. The processor can include one or more processor cores.

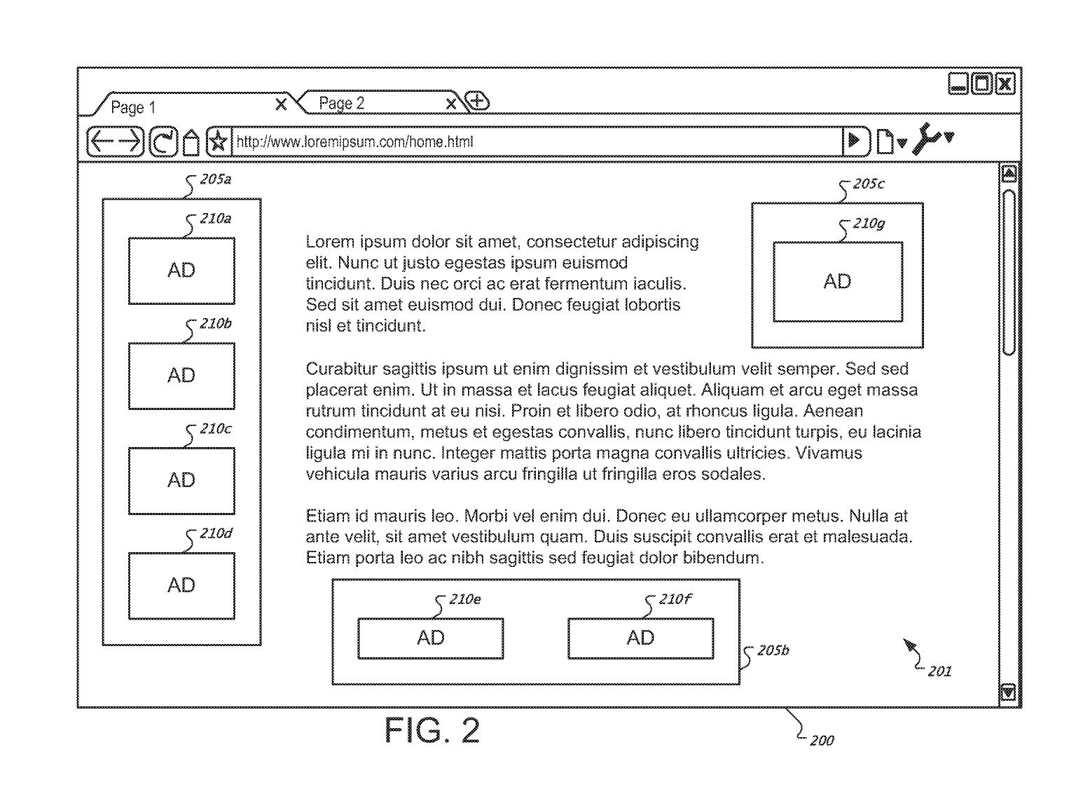

FIG. 2 shows an example of a layout of a webpage that includes frames with advertisement content. When rendered on a display output of a device 105 within a window 200 of a browser, a webpage 201 of a website can include one or more frames 205a-c that contain advertisement content. Each frame 205a-c can include one or more advertisement content units 210a-g. Each unit 210a-g can display its own unique advertisement within their respective frames 205a-c.

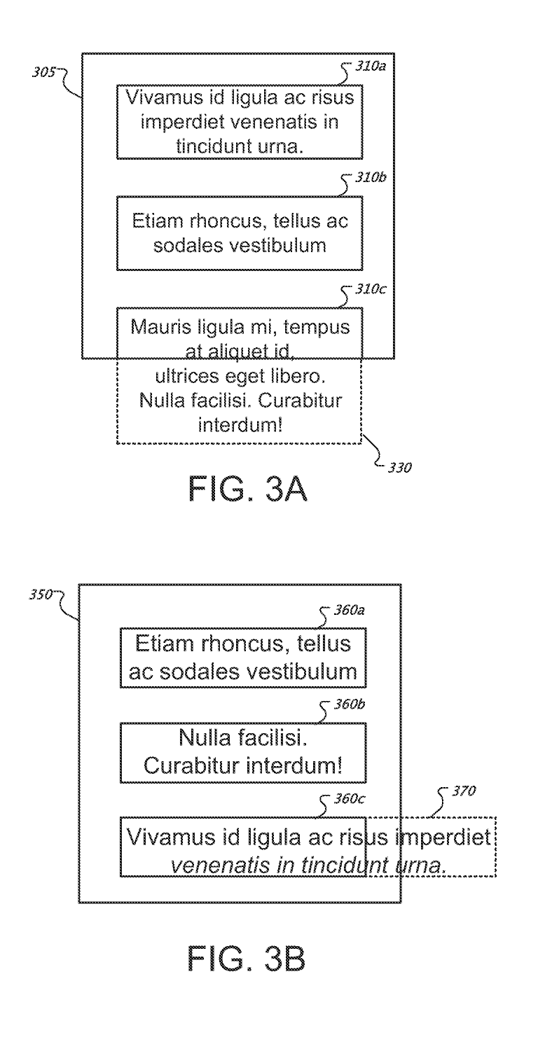

FIG. 3A shows an example of a layout of a frame that includes a truncated advertisement content unit. In this example, a frame 305 of a webpage includes four advertisement content units 310a-c, with two units 310a-b being fully displayed and one unit 310c being partially displayed. Here, the number of advertisement content units 310a-c provided by an advertisement server exceeded the number of advertisement content units that are fully displayable within the frame 305. A portion 330 of the text of the last unit 310c fails outside of the displayable area of the last unit 310c in the vertical direction. In addition, the portion 330 extends pass a vertical end of the frame 305. This portion 330 of the text is not displayed since it falls outside of the unit 310c and the frame 305 (however, for purposes of illustration, FIG. 3A shows this portion 330).

FIG. 3B shows another example of a layout of a frame that includes a truncated advertisement content unit. In this example, a frame 350 of a webpage includes three advertisement content units 360a-c, with two units 360a-b being fully displayed and a last unit 360c being partially displayed. A portion 370 of the text of the last unit 360c falls outside of the displayable area of the last unit 360c in the horizontal direction. This portion 370 of the text is not displayed since it fails outside of the unit 360c (however, for purposes of illustration, FIG. 3B shows this portion 370).

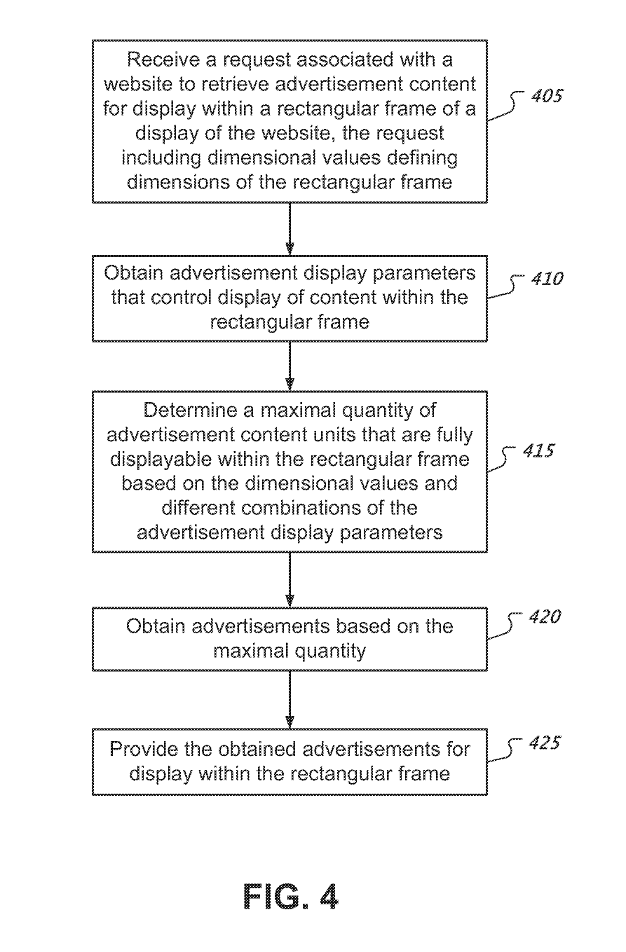

FIG. 4 shows an example of process that includes determining a maximal quantity of advertisement content units that are fully displayable within a rectangular frame. Other types of frames are possible such as circles, variants thereof, and polygons in general. In some implementations, a frame displayed to a website viewer can be a polygon or circular frame having a rectangular frame embedded inside, where the maximal quantity of advertisement content units is determined for the embedded rectangular frame. At 405, the process includes receiving a request associated with a website to retrieve advertisement content for display within a rectangular frame of a display of the website. The request includes dimensional values defining dimensions of the rectangular frame. The dimensional values can include a width value defining a width of the rectangular frame and a height value defining a height of the rectangular frame.

At 410, the process includes obtaining advertisement display parameters that

control display of content within the rectangular frame. Various examples of advertisement display parameters include font-types, font-sizes, browser types, operating system types, screen resolutions, margins, inter-advertisement padding values. Other types of parameters are possible. Obtaining advertisement display parameters can include accessing one or more advertisement display parameters that correspond, respectively, to one or more degrees of freedom. In some implementations, the process includes retrieving a configuration parameter associated with the website, where the configuration parameter constrains the plurality of different combinations of the advertisement display parameters in at least one degree of freedom. For example, a website publisher can request that all display advertisements being rendered using a specific font-type so that it matches content displayed in other areas of the website.

At 415, the process includes determining a maximal quantity of advertisement content units that are fully displayable within the rectangular frame based on the dimensional values and different combinations of the advertisement display parameters. Determining the maximal quantity can include determining maximal advertisement content unit quantities, respectively, for the different combinations of the advertisement display parameters, e.g., degrees of freedom. The largest one of the maximal advertisement content unit quantities can be selected to be the determined maximal quantity. In some implementations, to be conservative, the smallest one of the maximal advertisement content unit quantities can be selected to be the determined maximal quantity. In some implementations, determining the maximal quantity can include detecting a language associated with the website, and retrieving a word-length distribution associated with the language, where the maximal quantity is further based on the word-length distribution.

At 420, the process includes obtaining advertisements based on the maximal quantity. Obtaining advertisements can include querying an advertisement content database to retrieve advertisement descriptions. An advertisement description can include advertisement text, advertisement graphics, or both. At 425, the process includes providing the obtained advertisements for display within the rectangular frame. Providing the obtained advertisements can include sending the advertisement descriptions via Hypertext Transfer Protocol (HTTP) to a browser running on a device, such as a laptop, tablet, or mobile phone. Based on the advertisement descriptions, the browser can render advertisement content within the rectangular frame.

In some implementations, the process, at 415, can iterate over the degrees of freedom to determine a maximal quantity of advertisements. The number of degrees of freedom can be constrained based on a publisher's user interface controls. Such controls can be indicated in the request received at 405 or be retrieved from a database. For example, the publisher may request that only a specific font-type be used to display text advertisements. Accordingly, the font-type degree of freedom is consider to be fixed for this publisher, and the process, at 415, iterates over the remaining degrees of freedom. The process can use a subroutine to compute the maximum quantity of advertisements. For a given combination, the subroutine can iterate through every possible quantity of advertisements, starting with N=1 and going up to a fixed upper limit Nₘₐₓ (e.g., 10, 15, or 20). An imaginary W×H rectangle is subdivided into G smaller rectangles (one for each of the advertisements) and space is removed for padding between the G smaller rectangles. The subroutine can use the width and height of the smaller rectangle to lookup into a map of dimensions that fit a model advertisement to determine if an advertisement can fit into the space available. In some implementations, the model advertisement is based on an average amount of text in a representative sampling of advertisements in a database. In some implementations, actual advertisements are used. Based on the model advertisement fitting, the subroutine records this information and proceeds to determine whether N+1 advertisements can fit (e.g., the W×H rectangle is subdivided into G+1 smaller rectangles). If there is not enough space for N advertisements, then the routine can stop iterating for the current configuration, record that N−1 advertisements fit for this configuration, and move onto the next configuration (e.g. the next font-face or layout that is eligible). Once all configurations have been explored, the process can provide the largest number of advertisements possible with any eligible configuration.

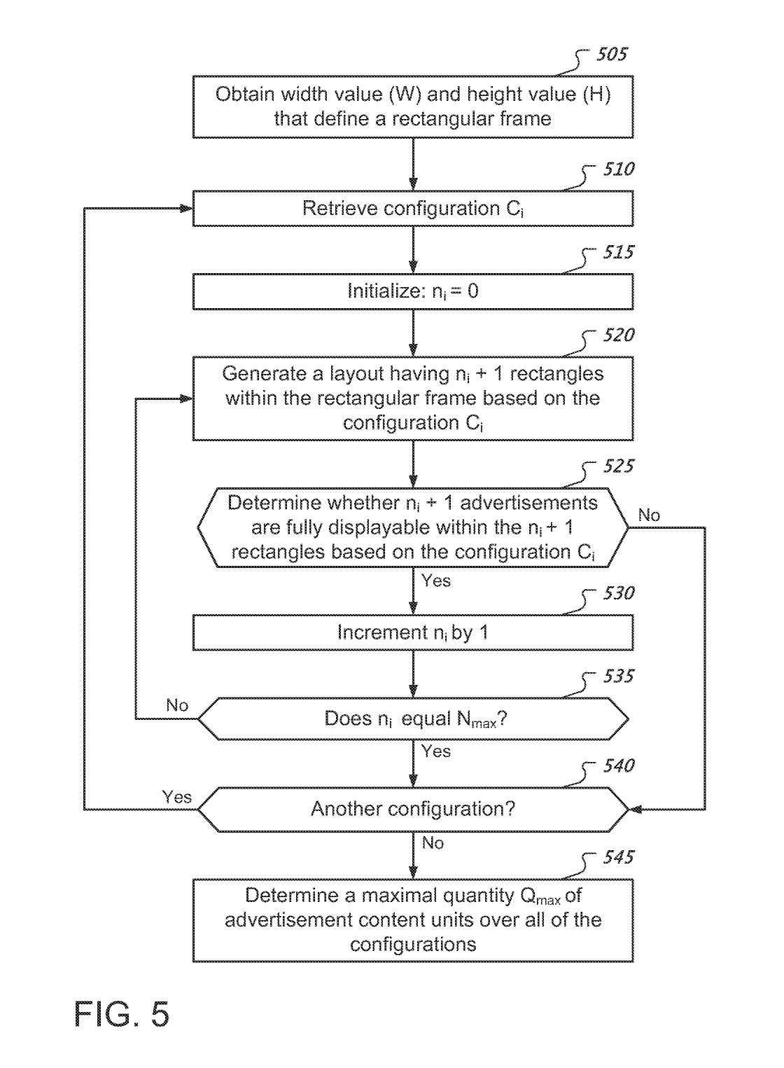

FIG. 5 shows an example of process to determine a maximal quantity of advertisement content units based on a group of configurations. At 505, the process obtains width value (W) and height value (H) that define a rectangular frame. Obtaining values can include receiving a data packet that defines the values. At 510, the process retrieves a configuration Cᵢ. Retrieving a configuration can include accessing an entry such as a K-tuple having K elements from a database, where K is the number of degrees of freedom. The database can include various combinations of parameters that are stored as different K-tuples. Within a retrieved K-tuple, there are specific values for each of the elements. In an implementation where a 3-tuple defines a font-type, font-size, and line-spacing, examples of retrieved 3-tuples include <Arial, 12 pt, 2>, <Arial, 14 pt, 2>, <Cambria, 12 pt, 2>, and <Cambria, 14 pt, 2>. In some implementations, retrieving a configuration includes iterating through various arrays of specific parameters, e.g., a first array of different font-types, a second array of different font-sizes, and a third array of different line-spacing values. At 515, the process initializes n,to zero, where nᵢ is associated with Cᵢ.

At 520, the process generates a layout having nᵢ+1 rectangles within the rectangular frame based on the configuration Cᵢ. At 525, the process determines whether nᵢ+1 advertisements are fully displayable within the nᵢ+1 rectangles based on the configuration Cᵢ. The process can include calculating the dimensions of the nᵢ+1 rectangles based on the configuration Cᵢ. For example, given a vertical inter-unit spacing value of 5 pixels that controls a vertical spacing between the rectangles and the obtained height value at 505, a vertical spacing between the nᵢ+1 rectangles can be set, and a height dimension of each of the n+1 rectangles can be determined. Note that all of the nᵢ rectangles can have the same width and height dimensions. In some implementations, the determining at 525 whether a model advertisement can lit within the space defined by the dimensions of one of the nᵢ+1 rectangles. The model advertisement can be formatted according to the configuration Cᵢ and a predetermined character count for an advertisement (e.g., each advertisement contains no more than 100 characters including spaces). At 530, the process increments nᵢ by one based on the nᵢ+1 advertisements being fully displayable. Based on the advertisements being fully displayable, at 535, the process determines whether n, equals Nₘₐₓ. If nᵢ does not equal Nₘₐₓ, the process repeats at 520,

If the advertisements are not fully displayable at 520, the process continues at 540 by determining whether there is another configuration. If there is another configuration, the process continues at 510 to retrieve the configuration and perform additional processing. If there are no more configurations, the process continues at 545 to determine a maximal quantity Qₘₐₓ of advertisement content units over ail of the configurations Cᵢ and their corresponding final nᵢ values. In some implementations, the process uses the expression:

$${Q}_{ma x} = {max}_{i} {n}_{i}$$

to determine the Qₘₐₓ maximal quantity. The process can use the Qₘₐₓ value to retrieve a corresponding number of advertisements from an advertisement database, and provide the advertisements to a browser.

In some implementations, a technique includes receiving a request associated with a website to retrieve advertisement content for display within a rectangular frame of a display of the website, the request including dimensional values defining dimensions of the rectangular frame, the dimensional values including a width value defining a width of the rectangular frame and a height value defining a height of the rectangular frame; obtaining advertisement display parameters that control display of content within the rectangular frame; determining a maximal quantity of advertisement content units that are fully displayable within the rectangular frame based on the dimensional values and a plurality of different combinations of the advertisement display parameters; obtaining advertisements based on the maximal quantity; and providing the obtained advertisements for display within the rectangular frame.

Embodiments of the subject matter and the operations described in this document can be implemented in digital electronic circuitry, or in computer software, firmware, or hardware, including the structures disclosed in this document and their structural equivalents, or in combinations of one or more of them. Embodiments of the subject matter described in this document can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this document can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this document can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this document can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this document, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this document contains many specific implementation details, these should not be construed as limitations on the scope of any inventions or of what may be claimed, but rather as descriptions of features specific to particular embodiments of particular inventions. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that ail illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving a request associated with a website to retrieve advertisement content for display within a frame of a display of the website, the request comprising dimensional values defining dimensions of the frame;
obtaining advertisement display parameters that control display of content within the frame;
determining a maximal quantity of advertisement content units that are fully displayable within the frame based on the dimensional values and a plurality of different combinations of the advertisement display parameters, wherein determining the maximal quantity comprises (i) determining maximal advertisement content unit quantities, respectively, for the different combinations of the advertisement display parameters; and (ii) selecting one of the maximal advertisement content unit quantities as the determined maximal quantity;
obtaining advertisements based on the determined maximal quantity; and
providing the obtained advertisements for display within the frame.

2. The method of claim 1, wherein selecting one of the maximal advertisement content unit quantities as the determined maximal quantity comprises selecting the largest one of the maximal advertisement content unit quantities as the determined maximal quantity.

3. The method of claim 1, wherein the frame is a rectangular frame, wherein the dimensional values comprise a width value defining a width of the rectangular frame and a height value defining a height of the rectangular frame, and wherein determining the maximal quantity of advertisement content units comprises dividing the rectangular frame into multiple smaller rectangular frames based on the width value, the height value, or both.

4. The method of claim 1, wherein the advertisement display parameters comprise font-types, font-sizes, browser types, operating system types, screen resolutions, or inter-advertisement padding values.

5. The method of claim 1, wherein obtaining advertisement display parameters comprises:
accessing first advertisement display parameters that correspond to a first degree of freedom; and
accessing second advertisement display parameters that correspond to a different second degree of freedom.

6. The method of claim 1, further comprising:
retrieving a configuration parameter associated with the website, wherein the configuration parameter constrains the plurality of different combinations of the advertisement display parameters in at least one degree of freedom.

7. The method of claim 1, wherein determining the maximal quantity comprises: detecting a language associated with the website; and
retrieving a word-length distribution associated with the language, the maximal quantity being further based on the word-length distribution.

8. A system comprising:
a network interface configured to receive data comprising a request associated with a website to retrieve advertisement content for display within a frame of a display of the website, the request comprising dimensional values defining dimensions of the frame; and
a processor in communication with the network interface configured to perform operations that comprise:
obtaining advertisement display parameters that control display of content within the frame;
determining a maximal quantity of advertisement content units that are fully displayable within the frame based on the dimensional values and a plurality of different combinations of the advertisement display parameters, wherein determining the maximal quantity comprises (i) determining maximal advertisement content unit quantities, respectively, for the different combinations of the advertisement display parameters; and (ii) selecting one of the maximal advertisement content unit quantities as the determined maximal quantity;
obtaining advertisements based on the determined maximal quantity; and
providing the obtained advertisements for display within the frame.

9. The system of claim 8, wherein selecting one of the maximal advertisement content unit quantities as the determined maximal quantity comprises selecting the largest one of the maximal advertisement content unit quantities as the determined maximal quantity.

10. The system of claim 8, wherein the frame is a rectangular frame, wherein the dimensional values comprise a width value defining a width of the rectangular frame and a height value defining a height of the rectangular frame, and wherein determining the maximal quantity of advertisement content units comprises dividing the rectangular frame into multiple smaller rectangular frames based on the width value, the height value, or both.

11. The system of claim 8, wherein the advertisement display parameters comprise font-types, font-sizes, browser types, operating system types, screen resolutions, or inter-advertisement padding values.

12. The system of claim 8, wherein obtaining advertisement display parameters comprises:
accessing first advertisement display parameters that correspond to a first degree of freedom: and
accessing second advertisement display parameters that correspond to a different second degree of freedom.

13. The system of claim 8, wherein the operations further comprise:
retrieving a configuration parameter associated with the website, wherein the configuration parameter constrains the plurality of different combinations of the advertisement display parameters in at least one degree of freedom.

14. The system of claim 8, wherein determining the maximal quantity comprises:
detecting a language associated with the website; and
retrieving a word-length distribution associated with the language, the maximal quantity being further based on the word-length distribution.

15. A system comprising:
a first server configured to receive data comprising a request associated with a website to retrieve advertisement content for display within a frame of a display of the website, the request comprising dimensional values defining dimensions of the frame; and
a second server configured to perform operations comprising: obtaining advertisement display parameters that control display of content within the frame; and determining a maximal quantity of advertisement content units that are fully displayable within the frame based on the dimensional values and a plurality of different combinations of the advertisement display parameters, wherein determining the maximal quantity comprises (i) determining maximal advertisement content unit quantities, respectively, for the different combinations of the advertisement display parameters; and (ii) selecting one of the maximal advertisement content unit quantities as the determined maximal quantity,
wherein the first server is configured to obtain advertisements based on the determined maximal quantity and provide the obtained advertisements for display within the frame.

16. The system of claim 15, wherein selecting one of the maximal advertisement content unit quantities as the determined maximal quantity comprises selecting the largest one of the maximal advertisement content unit quantities as the determined maximal quantity.

17. The system of claim 15, wherein the frame is a rectangular frame, wherein the dimensional values comprise a width value defining a width of the rectangular frame and a height value defining a height of the rectangular frame, and wherein determining the maximal quantity of advertisement content units comprises dividing the rectangular frame into multiple smaller rectangular frames based on the width value, the height value, or both.

18. The system of claim 15, wherein the advertisement display parameters comprise font-types, font-sizes, browser types, operating system types, screen resolutions, or inter-advertisement padding values.

19. The system of claim 15, wherein obtaining advertisement display parameters comprises:
accessing first advertisement display parameters that correspond to a first degree of freedom: and
accessing second advertisement display parameters that correspond to a different second degree of freedom.

20. The system of claim 15, wherein the operations further comprise:
retrieving a configuration parameter associated with the website, wherein the configuration parameter constrains the plurality of different combinations of the advertisement display parameters in at least one degree of freedom.
